(19) United States
(12) Patent Application Publication
(10) Pub. No.: US 2025/0035591 A1
(43) Pub. Date: Jan. 30, 2025

(54) SYSTEMS AND METHODS FOR ACOUSTIC MONITORING OF TRAYED DISTILLATION COLUMNS

(71) Applicant: Dow Global Technologies LLC, Midland, MI (US)

(72) Inventors: Sherine George, Missouri City, TX (US); Patrick L. Heider, Midland, MI (US); Zhenyu Wang, Pearland, TX (US)

(73) Assignee: Dow Global Technologies LLC, Midland, MI (US)

(21) Appl. No.: 18/716,348

(22) PCT Filed: Dec. 7, 2022
(86) PCT No.: PCT/US2022/081061

§ 371 Date: Jun. 4, 2024

Related U.S. Application Data
(60) Provisional application No. 63/287,201, filed on Dec. 8, 2021.

(51) Int. Cl. G01N 29/24; G01N 29/12; G01N 29/44

(52) U.S. Cl. CPC G01N 29/2418; G01N 29/12; G01N 29/4445; G01N 29/4454; G01N 29/4472; G01N 2291/014

(57) ABSTRACT

A method is provided for detecting an operational condition of a vessel containing two fluid phases moving past each other. The method may include providing a fiber optic cable around an exterior surface of the vessel, receiving time domain data comprising distributed acoustic sensing measurements from the fiber optic cable at a plurality of locations along the exterior surface of the vessel, determining frequency domain data at each of the plurality of locations based on the time domain data, performing an analysis of the frequency domain data and/or the time domain data using a pre-trained model, and determining the operational condition of the vessel based on the analysis.

### CROSS-REFERENCE TO RELATED APPLICATION

This application claims the benefit of and priority to U.S. Application Ser. No. 63/287,201 filed Dec. 8, 2021, and entitled “SYSTEMS AND METHODS FOR ACOUSTIC MONITORING OF TRAYED DISTILLATION COLUMNS,” the entire contents of which are incorporated by reference in the present disclosure

### TECHNICAL FIELD

The present specification relates to monitoring distillation columns, and more particularly, to systems and methods for acoustic monitoring of trayed distillation columns.

### BACKGROUND

Distillation columns may be used to separate a mixture of two liquids into its components parts. The distillation column may be filled with a liquid mixture, which may be heated to a temperature above the boiling point of one of the components but below the boiling point of the other component. This may cause the component with the lower boiling point to evaporate into a gas, while the component with the higher boiling point remains a liquid. The gas component may be separated from the liquid component and condensed back into a liquid in another container, thereby separating the mixture into its components parts.

A trayed distillation column may comprise a plurality of trays stacked vertically within the distillation column. The mixture liquid may enter the top of the trayed distillation column and may flow across the length of each tray, and down through a series of downcomers. As the mixture is heated and one of the components becomes a gas, the gas may rise up through the trays to the top of the trayed distillation column where it may be separated from the remaining liquid.

During operation, a trayed distillation column may experience a number of operational conditions, which may degrade its performance. The ability to detect these operational conditions may allow a technician to correct them in order to improve the performance of the trayed distillation column. One way of detecting the performance of a trayed distillation column is using a gamma scan to produce high resolution information about the distillation column. While a gamma scan is able to detect an operational condition of a distillation column, it only gives a snapshot at one instant in time, and cannot be set up to continually scan a distillation column. It is also expensive and involves radioactive sources, which have inherent safety risks.

During operation of a trayed distillation column, temperature and pressure measurements of a trayed distillation column can be taken. While these measurements may give some indication of the operational condition of a distillation column, the information obtained is limited, and typically cannot provide a complete understanding of local performance. Furthermore, temperature and pressure measurements generally require position sensing elements through the column wall of the distillation column. This limits the ability to install the sensing elements on an operational column and is more expensive to modify in an existing column. Accordingly, a need exists for an improved method of detecting an operational condition of a trayed distillation column during operation.

### SUMMARY

In one embodiment, a method for detecting an operational condition of a vessel containing two fluid phases moving past each other may include providing a fiber optic cable around an exterior surface of the vessel, receiving time domain data comprising distributed acoustic sensing measurements from the fiber optic cable at a plurality of locations along the exterior surface of the vessel, determining frequency domain data at each of the plurality of locations based on the time domain data, performing an analysis of the frequency domain data and/or the time domain data using a pre-trained model, and determining the operational condition of the vessel based on the analysis.

In another embodiment, a method for training a model to detect an operational condition of a vessel containing two fluid phases moving past each other may include providing a fiber optic cable around an exterior surface of the vessel, receiving, from the fiber optic cable at a plurality of locations along the exterior surface of the vessel, time domain data comprising distributed acoustic sensing measurements at a plurality of time steps, wherein the time domain data at each time step is labeled based on the operational condition of the vessel at the time step when the time domain data was collected, determining frequency domain data, associated with each of the operational conditions, at each of the plurality of locations based on the time domain data, and training the model to determine the operational condition of the vessel based on the associations between the frequency domain data and/or the time domain data, and the labeled operational conditions.

In another embodiment, a system to determine an operational condition of a vessel containing two fluid phases moving past each other may include the vessel, a fiber optic cable positioned around an exterior surface of the vessel, and a control unit. The control unit may be configured to receive time domain data comprising distributed acoustic sensing measurements from the fiber optic cable at a plurality of locations along the exterior surface of the vessel, determine frequency domain data at each of the plurality of locations based on the time domain data, perform an analysis of the frequency domain data and/or the time domain data using a pre-trained model, and determine the operational condition of the vessel based on the analysis.

### BRIEF DESCRIPTION OF THE DRAWINGS

The embodiments set forth in the drawings are illustrative and exemplary in nature and not intended to limit the disclosure. The following detailed description of the illustrative embodiments can be understood when read in conjunction with the following drawings, where like structure is indicated with like reference numerals and in which:

FIG. 1 schematically depicts a portion of an example trayed distillation column, according to one or more embodiments shown and described herein;

FIG. 2A depicts an exterior view of a trayed distillation column, according to one or more embodiments shown and described herein;

FIB. 2B schematically depicts an interior view of the trayed distillation column of FIG. 2A;

FIG. 2C depicts an exterior view of the trayed distillation column of FIG. 2A with a fiber optic cable provided around its surface, according to one or more embodiments shown and described herein;

FIG. 2D schematically depicts a system for performing acoustic monitoring of a trayed distillation column, according to one or more embodiments shown and described herein

FIG. 3 depicts a schematic diagram of the control unit of FIG. 2D, according to one or more embodiments shown and described herein;

FIG. 4 schematically depicts a plurality of memory modules of the control unit of FIG. 3, according to one or more embodiments shown and described herein;

FIG. 5 depicts an illustration of classification of different operating conditions with a trained model, according to one or more embodiments shown and described herein;

FIG. 6 depicts a flowchart of an example method for training the control unit of FIG. 3 to perform acoustic monitoring of a trayed distillation column, according to one or more embodiments shown and described herein;

FIG. 7 depicts a flowchart of an example method for operating the control unit of FIG. 3 to perform acoustic monitoring of a trayed distillation column, according to one or more embodiments shown and described herein

FIG. 8A depicts an illustration of regression analysis to determine an amount of jet flooding for sample data; and

FIG. 8B depicts an illustration of regression analysis to determine an amount of downcomer backup for sample data.

### DETAILED DESCRIPTION

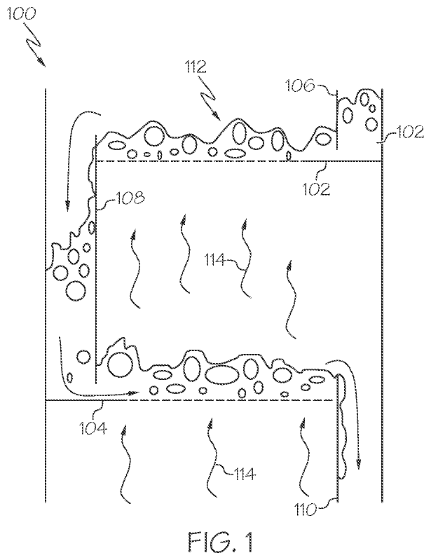

The embodiments disclosed herein describe systems and methods for acoustic monitoring of trayed distillation columns. FIG. 1 shows a portion of an example trayed distillation column 100. In the example of FIG. 1, the distillation column 100 includes two trays 102 and 104, and three downcomers 106, 108, and 110. The trays 102 and 104 have sieve holes along their surface.

In the example of FIG. 1, a liquid 112, which is a mixture of two components to be separated, flows down the downcomer 106, along the tray 102, down the downcomer 108, along the tray 104, and down the downcomer 110. As the liquid 112 is heated, one component of the mixture becomes a vapor 114, which rises up through the sieve holes in the trays 104, 102, so that it can be separated from the remaining liquid component of the liquid 112. The vapor 114 passing through the sieve holes in the trays 102, 104, which prevents the liquid 112 from weeping through the sieve holes.

During operation of the trayed distillation column 100, a number of operational conditions may occur that degrade its performance, such as weeping, foaming, fouling, jet flooding, and downcomer backup. Weeping is when the liquid falls or weeps through the sieve holes of the trays 102, 104, rather than being held up by the vapor 114 and flowing over the sieve holes. Foaming is when the liquid 112 expands and forms bubbles, which prevents proper contact between the liquid 112 and the vapor 114. Fouling is when foreign material obscures passages on the trays, thereby impeding a proper flow of the vapor 114 through the trays 102, 104. Jet flooding is when an entrainment of froth accumulates underneath a tray, preventing a proper flow of the vapor 114 through the trays 102, 104. Downcomer backup is when the flow of the liquid 112 through the distillation column 100 is such that one or more of the downcomers 106, 108, 110 overflows and backs up, thereby preventing proper flow of the liquid 112 through the distillation column 100. Other operational conditions may also occur that degrade the performance of the trayed distillation column 100.

Embodiments disclosed herein are direct to systems and methods for detecting different operational conditions of a trayed distillation column while it is operating. In particular, embodiments disclosed herein utilize acoustic monitoring to detect operational conditions of a trayed distillation column.

In embodiments, a fiber optic cable is wrapped around a trayed distillation column. The fiber optic cable may behave like a plurality of microphones placed at different locations along the distillation column by determining strain measurements at each such location. As such, the fiber optic cable may be used as a sensor to detect acoustic sensing measurements at various points along the distillation column at different times (e.g., every 2 meters at a frequency of 20 kHz). The acoustic sensing measurements can be used to determine an operational condition of the distillation column using a pre-trained model, as using the techniques described herein.

The model can be trained to determine an operational condition of a distillation column based on the acoustic sensing measurements received by the fiber optic cable wrapped around the distillation column, using the techniques described herein. In one example, in a lab setting, a small-scale model of a distillation column (referred to herein as a lab column) may be used for which the flow rate and other parameters may be controlled to artificially cause various operational conditions to occur with the lab column. As such, in this example, acoustic sensing measurements may be collected for each artificially caused operational condition and labeled accordingly. A model may then be trained to classify and/or determine an extent of an operational condition of the lab column based on the labeled data gathered during each of the artificially caused operational conditions, as disclosed herein. Training a model for the lab column may be used as a proof of concept.

In another example, in an actual distillation column (referred to herein as a commercial column), it may not be possible to artificially cause operational conditions to occur within the commercial column. Accordingly, in this example, acoustic sensing measurements may be collected from the commercial column while it runs during normal operation. Over time, it is expected that the commercial column will experience a variety of operational conditions naturally. Thus, supplemental data (e.g., flow rate, temperature, and pressure data) may be collected from the commercial column along with the acoustic sensing measurements. An operational condition of the commercial column may then be determined based on the supplemental data and the acoustic sensing data may be labeled based on the determined operational conditions. A model may be trained to classify and/or determine an extent of an operational condition of the commercial column based on the labeled data from the commercial column. Once a model is trained for either the lab column or the commercial column, the appropriate model may be used to determine an operational condition of the lab column or the commercial column during real-time operation.

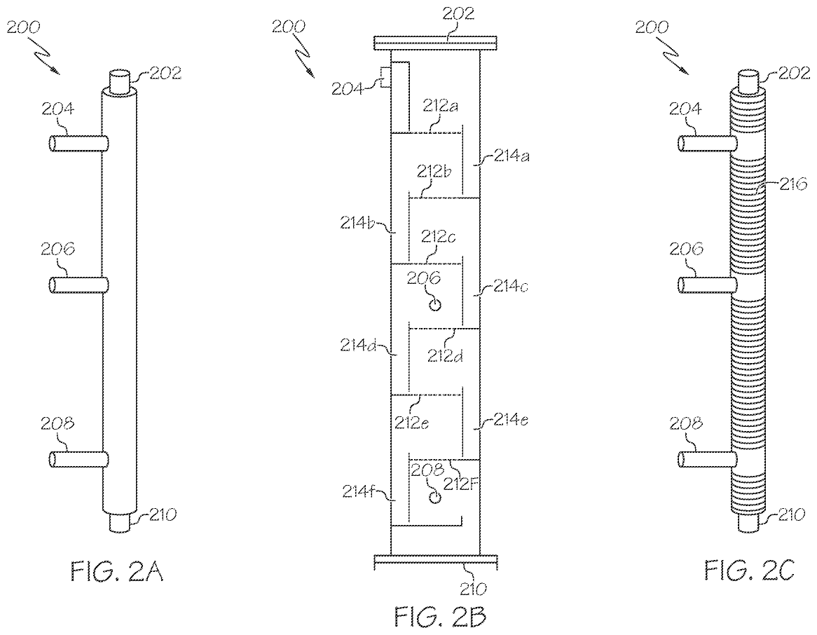

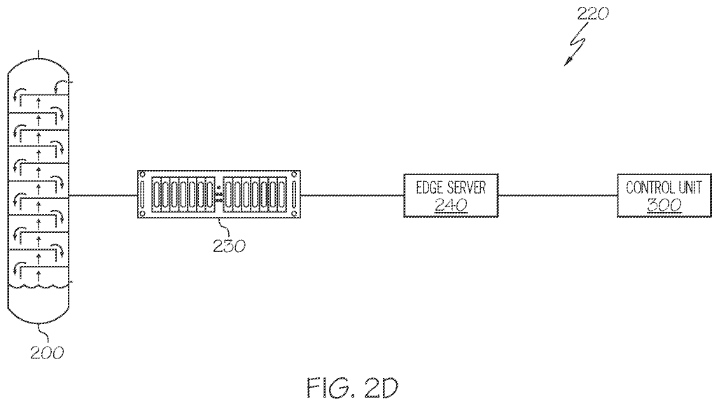

FIG. 2A depicts an external view of an example trayed column 200 (e.g., a trayed distillation column) and FIG. 2B depicts a schematic diagram of the internal components of the trayed column 200. In the examples of FIGS. 2A and 2B, the trayed column 200 is a lab column as discussed above. However, in other examples, the trayed column 200 may be a commercial column as discussed above.

In the example of FIG. 2A, the trayed column 200 comprises a vapor outlet 202, a liquid inlet 204, a middle gas inlet 206, a bottom gas inlet 208, and a liquid outlet 210. The trayed column 200 also comprises a plurality of trays, 212a, 212b, 212c, 212d, 212e, 212f, and a plurality of downcomers 214a, 214b, 214c, 214d, 214e, 214f. However, in other examples, the trayed column 200 may include any number of inlets, outlets, trays, and downcomers.

In operation, a liquid may be input into the liquid inlet 204 and may flow across each of the trays and down each of the downcomers so as to move downward through the trayed column 200. The liquid may be heated to cause one component of the liquid to evaporate into a vapor, which may rise upwards through the trays of the trayed column 200. Embodiments disclosed herein may detect an operational condition of the trayed column 200 in real-time while the trayed column 200 is operating. While embodiments disclosed herein are directed towards detecting an operational condition of a trayed distillation column, the systems and methods disclosed herein may be used to detect an operational condition of any vessel containing two fluid phases moving past each other (e.g., other types of distillation columns such as packed columns, trickle-bed reactors, and the like).

FIG. 2C depicts an example of the trayed column 200 with a fiber optic cable 216 wrapped around the exterior surface. As disclosed herein, the fiber optic cable 216 may act as a sensor to capture acoustic sensing measurements from the trayed column 200. As shown in FIG. 2C, the fiber optic cable 216 may be wrapped around the circumference of the trayed column 200 spanning most of the length of the trayed column 200. A laser pulse may be propagated through the fiber optic cable 216 and backscattered light may be measured by a sensor. The backscattered light may be affected by axial dynamic strain or displacement of the optical fibers of the fiber optic cable 216, which may be caused by acoustic signals output by the trayed column 200. Thus, measurement of the backscattered light may indicate acoustic features of the trayed column 200.

In embodiments, the amplitude and phase of acoustic signals from the trayed column 200 may be measured. In the illustrated example, Rayleigh backscatter is measured to determine the amplitude and phase of an acoustic signal. However, in other examples, other measurements of the backscattered light may be taken (e.g., Brillouin backscatter) to determine the acoustic signal from the trayed column 200.

Experiments have shown that acoustic signals output by the trayed column 200 may differ depending on an operational condition of the trayed column 200. More specifically, each type of operational condition may have a distinct acoustic signal that can be measured. Therefore, measuring the acoustic signals of the trayed column 200 detected by the fiber optic cable 216 may provide an indication of an operational condition of the trayed column 200, as explained in further detail herein. Furthermore, by wrapping the fiber optic cable 216 around the circumference and along the length of the trayed column 200, acoustic signals may be detected at different points along the trayed column 200. Thus, the position at which certain operational conditions occur may be determined.

FIG. 2D depicts a schematic diagram of a system 220 for performing acoustic monitoring of trayed distillation columns. In the example of FIG. 2D, the system 220 includes the trayed column 200 of FIGS. 2A-2C, a distributed acoustic sensor (DAS) interrogator 230, an edge server 240, and a control unit 300.

The trayed column 200 may be either a lab column or a commercial column as discussed above. The DAS interrogator 230 may receive the distributed acoustic sensing measurements from the fiber optic cable 216 and transmit the received data to the edge server 240. In the illustrated example, the edge server 240 is a computing device located in the same facility as the trayed column 200. However, in other examples, the edge server 240 may be located remotely from the trayed column 200.

The edge server 240 may receive the acoustic sensing measurements from the DAS interrogator 230 and may perform unsupervised machine learning methods to leverage underlying patterns of the spatiotemporal matrices produced by the acoustic sensing measurements and construct lower dimensional representations of such data. Such representations may then be used to monitor the process and detect changes in this unlabeled raw data set. In particular, after the model is trained by the control unit 300, as explained below, the control unit 300 may monitor the trayed column 200 in real-time to determine its operational condition based on the acoustic sensing measurements from the fiber optic cable 216. However, the fiber optic cable 216 may output a large amount of data (e.g., several TB/hour). As such, if all the data received by the DAS interrogator 230 is transferred to the control unit 300, the computing resources of the control unit 300 may be insufficient to process the data in a reasonable amount of time. As such, the edge server 240 may filter the data that is transmitted to the control unit 300.

In embodiments, the edge server 240 may monitor the data received from the DAS interrogator 230 and analyze the received data using unsupervised machine learning techniques. In particular, the edge server 240 may determine when the data received from the DAS interrogator 230 has changed in a manner that suggests that the operational condition of the trayed column 200 has changed. When this occurs, the edge server 240 may begin to transmit the data received from the DAS interrogator 230 to the control unit 300 such that the control unit 300 may determine the operational condition of the trayed column 200 using the techniques described herein.

In some examples, the system 220 may not include the edge server 240. In these examples, all of the data received by the DAS interrogator 230 is transferred to the control unit 300. Furthermore, in examples where the system 220 includes the edge server 240, the edge server 240 may be omitted or may transfer all data received by the DAS interrogator 230 during training of the model by the control unit 300. During training of the model, it may be desirable to utilize as much data as possible to train the model. As such, filtering the data transmitted to the control unit 300 may not be desired. As such, the edge server 240 may not filter data transmitted to the control unit 300 during training of the model.

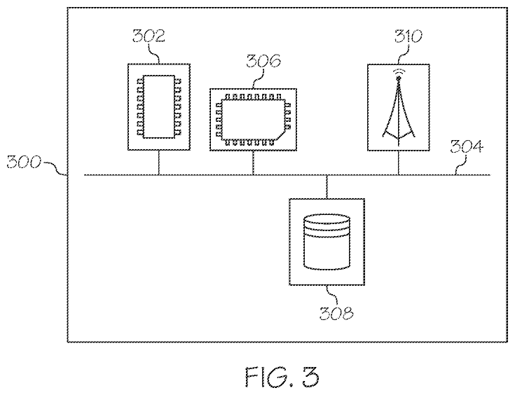

FIG. 3 schematically depicts an example configuration of the control unit 300 of FIG. 2. In the illustrated example, the control unit 300 may be a remote computing device (e.g., a cloud computing device). However, in other examples, the control unit 300 may be a computing device located in the same location as the edge server 240. In some examples, the edge server 240 and the control unit 300 may be combined into a single computing device. In the illustrated example, the control unit 300 includes one or more processors 302, a communication path 304, one or more memory modules 306, a data storage component 308, and network interface hardware 310, the details of which will be set forth in the following paragraphs.

Each of the one or more processors 302 may be any device capable of executing machine readable and executable instructions. Accordingly, each of the one or more processors 302 may be a controller, an integrated circuit, a microchip, a computer, or any other physical or cloud-based computing device. The algorithms, including the trained models, signal preprocessing, and noise removal methods discussed below, may be executed by the one or more processors 302. The one or more processors 302 are coupled to a communication path 304 that provides signal interconnectivity between various modules of the control unit 300. Accordingly, the communication path 304 may communicatively couple any number of processors 302 with one another, and allow the modules coupled to the communication path 304 to operate in a distributed computing environment. Specifically, each of the modules may operate as a node that may send and/or receive data. As used herein, the term “communicatively coupled” means that coupled components are capable of exchanging data signals with one another such as, for example, electrical signals via conductive medium, electromagnetic signals via air, optical signals via optical waveguides, and the like.

Accordingly, the communication path 304 may be formed from any medium that is capable of transmitting a signal such as, for example, conductive wires, conductive traces, optical waveguides, or the like. In some embodiments, the communication path 304 may facilitate the transmission of wireless signals, such as WiFi, Bluetooth®, Near Field Communication (NFC) and the like. Moreover, the communication path 304 may be formed from a combination of mediums capable of transmitting signals. In one embodiment, the communication path 304 comprises a combination of conductive traces, conductive wires, connectors, and buses that cooperate to permit the transmission of electrical data signals to components such as processors, memories, sensors, input devices, output devices, and communication devices. Additionally, it is noted that the term “signal” means a waveform (e.g., electrical, optical, magnetic, mechanical or electromagnetic), such as DC, AC, sinusoidal-wave, triangular-wave, square-wave, vibration, and the like, capable of traveling through a medium.

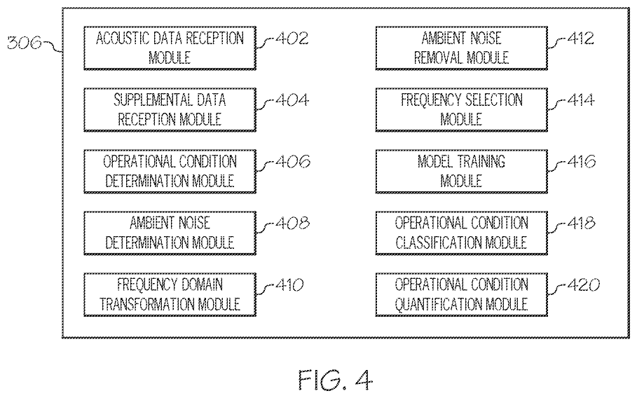

The control unit 300 includes one or more memory modules 306 coupled to the communication path 304. The one or more memory modules 306 may comprise RAM, ROM, flash memories, hard drives, or any device capable of storing machine readable and executable instructions such that the machine readable and executable instructions can be accessed by the one or more processors 302. The machine readable and executable instructions may comprise logic or algorithm(s) written in any programming language of any generation (e.g., 1GL, 2GL, 3GL, 4GL, or 5GL) such as, for example, machine language that may be directly executed by the processor, or assembly language, object-oriented programming (OOP), scripting languages, microcode, etc., that may be compiled or assembled into machine readable and executable instructions and stored on the one or more memory modules 306. Alternatively, the machine readable and executable instructions may be written in a hardware description language (HDL), such as logic implemented via either a field-programmable gate array (FPGA) configuration or an application-specific integrated circuit (ASIC), or their equivalents. Accordingly, the methods described herein may be implemented in any conventional computer programming language, as pre-programmed hardware elements, or as a combination of hardware and software components. The memory modules 306 are discussed in more detail below in connection with FIG. 4.

Referring still to FIG. 3, the example control unit 300 includes a data storage component 308. The data storage component 308 may store data received from the edge server 240 or data generated by the control unit 300. The data storage component 308 may also store other data used by the various components of the control unit 300. In particular, the data storage component 308 may store parameters of a trained model to determine the operational condition of the trayed column 200. This model may be referred to herein as, “the model”.

Still referring to FIG. 3, the control unit 300 comprises network interface hardware 310 for communicatively coupling the control unit 300 to the fiber optic cable 216. As such, the network interface hardware 310 may send data to the trayed column 200 and/or receive data from the edge server 240. The network interface hardware 310 may comprise a wired and/or wireless connection to the trayed column 200 and/or the edge server 240. In other examples, the network interface hardware 310 may be send data to and/or receive data from other computing devices. The network interface hardware 310 can be communicatively coupled to the communication path 304 and can be any device capable of transmitting and/or receiving data via a network. Accordingly, the network interface hardware 310 can include a communication transceiver for sending and/or receiving any wired or wireless communication. For example, the network interface hardware 310 may include an antenna, a modem, LAN port, Wi-Fi card, WiMax card, mobile communications hardware, near-field communication hardware, satellite communication hardware and/or any wired or wireless hardware for communicating with the fiber optic cable 216 and/or other networks and/or devices.

Referring now to FIG. 4, the one or more memory modules 306 include an acoustic data reception module 402, a supplemental data reception module 404, an operational condition determination module 406, an ambient noise determination module 408, a frequency domain transformation module 410, an ambient noise removal module 412, a frequency selection module 414, a model training module 416, an operational condition classification module 418, and an operational condition quantification module 420. Each of the acoustic data reception module 402, the supplemental data reception module 404, the operational condition determination module 406, the ambient noise determination module 408, the frequency domain transformation module 410, the ambient noise removal module 412, the frequency selection module 414, the model training module 416, the operational condition classification module 418, and the operational condition quantification module 420 may be a program module in the form of operating systems, application program modules, and other program modules stored in one or more memory modules 306. Such a program module may include, but is not limited to, routines, subroutines, programs, objects, components, data structures and the like for performing specific tasks or executing specific data types as will be described below.

The acoustic data reception module 402 may receive data from the edge server 240 comprising the acoustic sensing measurements captured by the fiber optic cable 216 positioned around the trayed column 200. In particular, the acoustic data reception module 402 may receive distributed acoustic sensing measurements from a plurality of locations along the exterior surface of the trayed column 200. The acoustic data reception module 402 may receive data either during training of the model, or during operation of the trayed column 200 after the model is trained.

The acoustic data reception module 402 may receive time domain from the fiber optic cable 216 (via the edge server 240). That is, the acoustic data reception module 402 may receive backscatter data from the fiber optic cable 216 at a plurality of points along the trayed column 200 at multiple points in time (e.g., every 2 m at a frequency of 10 kHz). The received time domain data may then be transformed into frequency domain data by the frequency domain transformation module 410, as described in further detail below. As data is received by the acoustic data reception module 402, the data may be stored in the data storage component 308.

In examples where the trayed column 200 is the commercial column, the supplemental data reception module 404 may receive supplemental data from the trayed column 200 other than the acoustic sensing measurements detected by the fiber optic cable 216. For example, the supplemental data reception module 404 may receive supplemental data comprising flow rates, temperature, and pressure values from the trayed column 200. This data may be used to determine operational conditions of the trayed column 200 when training the model. The supplemental data may be detected by various sensors measuring various parameters of the trayed column 200.

The operational condition determination module 406 may determine the operational condition of the trayed column 200 based on the supplemental data received by the supplemental data reception module 404, in examples where the trayed column 200 is the commercial column. In examples where the trayed column 200 is the lab column, an operator may artificially cause the trayed column 200 to enter a particular operational state by adjusting flow rates or other parameters of the trayed column 200. The acoustic sensing data received may then be labeled based on the operational condition caused by the operator.

However, in examples where the trayed column 200 is the commercial column, it may not be possible to cause the trayed column 200 to undergo different operational conditions on demand. As such, in these examples, the system 220 may allow the trayed column 200 to operate naturally and over time, it is expected that the trayed column 200 will experience different operational conditions in due course of operation. However, in order to label the received acoustic sensing data, it is necessary to determine the operational condition of the trayed column 200 at any given time. Accordingly, the supplemental data reception module 404 may receive supplemental data from the trayed column 200, and the operational condition determination module 406 may determine the operational condition of the trayed column 200 based on the supplemental data received by the supplemental data reception module 404. The acoustic sensing data may then be labeled based on the operational conditions determined by the operational condition determination module 406.

The ambient noise determination module 408 may determine ambient noise data, in the environment where the trayed column 200 is located. As discussed above, the fiber optic cable 216 measures an acoustic signal from the trayed column 200. However, if there is ambient noise present around the trayed column 200, the fiber optic cable 216 may detect the ambient noise, which may interfere with the data collected by the fiber optic cable 216. Accordingly, the ambient noise determination module 408 may determine the ambient noise, which can be subtracted from the data collected by the fiber optic cable 216 to remove this interference, as discussed in further detail below. In some examples, the ambient noise determination module 408 may determine the ambient noise based on acoustic sensing data received from points of the fiber optic cable 216 wrapped around the trayed column 200 at locations where fluid does not flow. In other examples, the ambient noise determination module 408 may determine the ambient noise based on acoustic sensing data received when the trayed column 200 is not in operation. The ambient noise determination module 408 may also determine time stamps when each piece of ambient noise data is determined. As such, the ambient noise data identified by the ambient noise determination module 408 may be aligned with the acoustic data received by the acoustic data reception module 402.

The frequency domain transformation module 410 may transform the time domain data received by the acoustic data reception module 402 into frequency domain data. The frequency domain data may comprise features to be used to train the model to detect an operational condition of the trayed column 200. After training, the frequency domain data may comprise features to be input into the trained model.

The frequency domain transformation module 410 may determine frequency domain data comprising amplitude and phase data at a plurality of frequency values at each of the locations along the trayed column 200 for which data is received by the acoustic data reception module 402. The frequency domain transformation module 410 may utilize a variety of techniques to transform time domain data into frequency domain data, including Fourier transform, Fast Fourier transform, Short Time Fourier transform, wavelet analysis, and the like. In the illustrated example, the frequency domain transformation module 410 determines amplitude and phase data at 12,500 different frequencies ranging from 0 Hz-12,500 Hz at 1 Hz intervals. However, in other examples, the frequency domain transformation module 410 may determine frequency data at any number of frequency values.

The ambient noise removal module 412 may remove the ambient noise identified by the ambient noise determination module 408 from the frequency domain data generated by the frequency domain transformation module 410. In particular, the frequency domain transformation module 410 may transform the acoustic sensing measurements representing ambient noise, as determined by the ambient noise determination module 408, to the frequency domain and the transformed ambient noise data may be removed from the frequency domain data. As such, the ambient noise removal module 412 may determine adjusted frequency domain data comprising the frequency domain data generated by the frequency domain transformation module 410 with the ambient noise signal removed. Accordingly, the adjusted frequency domain data determined by the ambient noise removal module 412 may eliminate any interference caused by ambient noise. While in the illustrated example, the ambient noise removal module 412 removes ambient noise from the frequency domain data output by the frequency domain transformation module 410, in other examples, the ambient noise removal module 412 may remove ambient noise from the time domain data received by the acoustic data reception module 402.

The frequency selection module 414 may be utilized during training to select certain frequencies from among the frequency values for which frequency domain data is obtained by the frequency domain transformation module 410. As discussed above, in the illustrated example, the frequency domain transformation module 410 obtains amplitude and phase information for 12,500 different frequency values. However, not all of these frequency values are contain a significant signal across operational conditions of the trayed column 200. Accordingly, the frequency selection module 414 may select a subset of frequency values that capture the most information associated with the operational conditions using regression analysis. The subset of frequencies selected by the frequency selection module 414 may be referred to herein as reduced frequency domain data.

In embodiments, all of the frequency values that are part of the frequency domain data determined by the frequency domain transformation module 410 comprise candidate frequencies (e.g., 12,500 candidate frequencies in the illustrated example). Then, an expert may review the frequency domain data to determine which candidate frequencies contribute a non-trivial amount of signal across operational conditions determined by the operational condition determination module 406. The frequency selection module 414 may then be programmed to remove frequency values that have a no signal or a trivial amount of signal across operational conditions. As such, the frequency selection module 414 may select a subset of frequency values from among the plurality of frequency values determined by the frequency domain transformation module 410 that capture the most information associated with the operational conditions.

The model training module 416 may train the model to determine an operational condition of the trayed column 200, as disclosed herein. The model training module 416 may train the model to classify the operational condition of the trayed column 200 into one of a plurality of operational conditions and/or determine an extent of the operational condition of the trayed column 200. In the illustrated example, the model training module 416 may train the model to classify the operational condition of the trayed column 200 into one of normal operation, weeping, fouling, and foaming, as disclosed herein. In addition, the model training module 416 may train the model to determine an extent of jet flooding and downcomer backup being experienced by the trayed column 200, as disclosed herein.

In embodiments, the model training module 416 may train the model to classify the frequency domain data into one of a plurality of operational conditions using multivariate discriminant analysis. In some examples, the model training module 416 may train the model to classify the frequency domain data and the time domain data into one of a plurality of operational conditions using multivariate discriminant analysis. In the illustrated example, the model training module 416 trains the model to classify the frequency domain data into one of a plurality of operational conditions using orthogonal partial least squares discriminant analysis (OPLS-DA). However, in other examples, other types of multivariate analysis may be used to train the model (e.g., partial least squares discriminant analysis).

In embodiments, the model training module 416 may perform the steps of determining a number of principal components, selecting important variables, and estimating parameter values corresponding to the selected variables. In a first step, a number of principal components are selected. In particular, the model training module 416 may determine principal components of the adjusted frequency domain data output by the ambient noise removal module 412. The model training module 416 may also determine scores of the principal components for different data sets (e.g., different operational conditions). An expert may then determine how many principal components should be included in the model. The expert may determine a number of principal components that explains the data well without overfitting.

In a second step, the model training module 416 may select important variables using variable importance in projection (VIP). In particular, the model training module 416 may uses VIP to determine how many frequencies among the frequencies selected by the frequency selection module 414 to include in the model.

In a third step, the model training module 416 may estimate parameter values corresponding to the selected variables. That is, the model training module 416 may estimate parameter values corresponding to the frequencies selected using VIP. The three steps described herein may be repeated in an iterative manner to train the model.

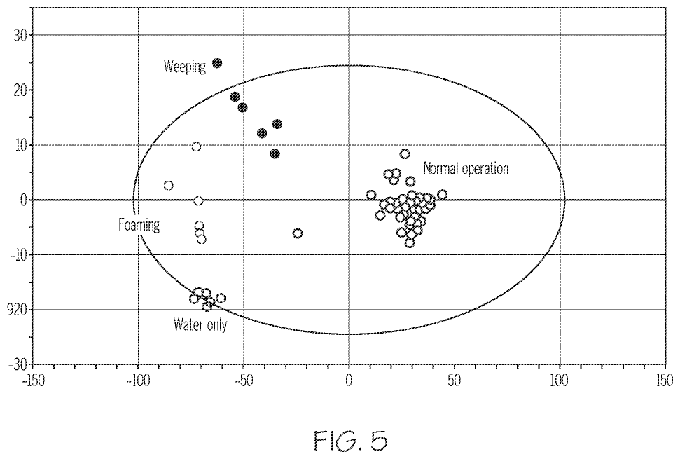

In one example, the model training module 416 may train the model to classify the frequency domain data into a particular operational condition based on the scores of the principal components. For example, FIG. 5 shows example data collected from the trayed column 200 under several different operational conditions. In the example of FIG. 5, the data was collected from a lab column. The lab column used in the example of FIG. 5 uses water and air, which are fed into the top and bottom of the device, respectively. Different operational conditions may be caused to occur within the device by adjusting the flow rates of the water and air.

In the example of FIG. 5, data was collected from a fiber optic cable wrapped around the device during four different operational conditions: normal operation, weeping, foaming, and only injecting water. During each operational condition, time domain data from the fiber optic cable was collected. This time domain was transformed into the frequency domain data and an OPLS-DA model was built for classification, using the techniques discussed above. FIG. 5 shows a two-dimensional plot of the first two principal components. As can be seen in FIG. 5, each operational condition tends to produce frequency domain data with principal components falling within a certain range. Thus, the model training module 416 may train the model, using the frequency domain data collected during different operational conditions, to determine a particular operational condition and visualize the results in a two-dimensional plot.

In addition to training the model to determine a particular operational condition, the model training module 416 may also train the model to determine an extent of certain operational conditions. For example, the model training module 416 may train the model to determine an amount of jet flooding or downcomer backup that is occurring in the trayed column 200 based on the frequency domain data and/or the time domain data.

In embodiments, the acoustic data reception module 402 may collect acoustic data associated with different operational conditions of different extents (e.g., jet flooding or downcomer backup). The frequency domain transformation module 410 may transform this time domain data into frequency domain data, which may be used training data that the model training module 416 may use to train the model to determine an extent of one or more operational conditions. In the illustrated example, the model training module 416 trains the model to determine an extent of an operational condition using partial least squares (PLS) regression. However, in other examples, the model training module 416 may train the model to determine an extent of an operational condition using other algorithms (e.g., other types of regression).

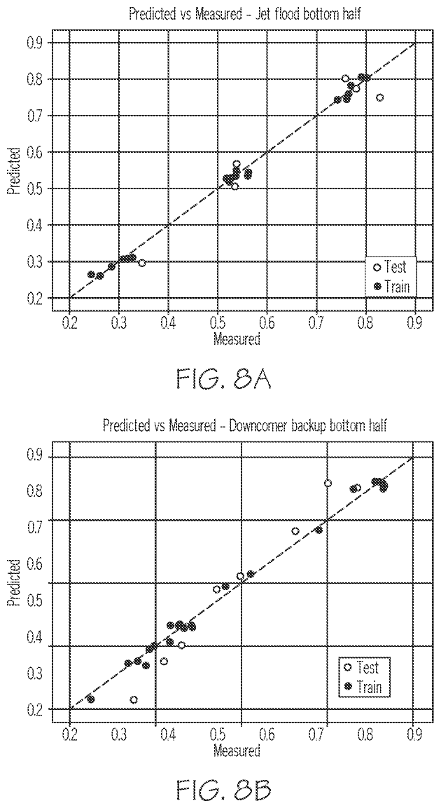

FIGS. 8A and 8B show example predictions of extents of operational conditions of the trayed column 200 using sample data as determined by the trained model. In the examples of FIGS. 8A and 8B, the data was collected from a lab column. In the examples of FIGS. 8A and 8B, PLS was used to determine the extent of operational conditions. FIG. 8A shows a predicted amount of jet flooding in the trayed column 200 and FIG. 8B shows a predicted amount of downcomer backup in the trayed column 200 for sample data.

Referring back to FIG. 4, after the model training module 416 has trained the model, the control unit 300 may use the trained model to determine an operational condition and/or an extent of an operational condition of the trayed column 200 in real-time based on received acoustic sensing measurements detected by the fiber optic cable 216. In particular, the operational condition classification module 418 may determine an operational condition of the trayed column 200 and the operational condition quantification module 420 may determine an extent of an operational condition of the trayed column 200, as disclosed herein.

The operational condition classification module 418 may classify the reduced frequency domain data determined by the frequency selection module 414 using the pre-trained model. In particular, the operational condition classification module 418 may classify the reduced frequency domain data into one of a plurality of operational conditions using multivariate discriminant analysis. In some examples, the operational condition classification module 418 may classify the reduced frequency domain data using the reduced frequency domain data and the time domain data received by the acoustic data reception module 402. In the illustrated example, the operational condition classification module 418 may classify the operational condition of the trayed column 200 into one of normal operation, weeping, fouling, or foaming. However, in other examples, the operational condition classification module 418 may classify the operational condition of the trayed column 200 into other operational conditions.

The operational condition quantification module 420 may determine an extent of an operational condition of the trayed column 200 using the pre-trained model. In particular, the operational condition quantification module 420 may use the pre-trained model to determine an extent of an operational condition of the trayed column 200 based on the reduced frequency domain data determined by the frequency selection module 414 and/or the time domain data received by the acoustic data reception module 402. In the illustrated example, the operational condition quantification module 420 may determine an extent of jet flooding and downcomer backup during operation of the trayed column 200. However, in other examples, the operational condition quantification module 420 may determine an extent of other operational conditions of the trayed column 200.

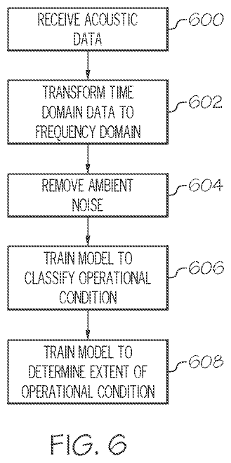

FIG. 6 depicts a flowchart of an example method for training the model to detect an operational condition and/or an extent of an operational condition of the trayed column 200. At step 600, the acoustic data reception module 402 receives acoustic data sensing measurements from the fiber optic cable 216 wrapped around the trayed column 200 (via the DAS interrogator 230). This data may comprise time domain acoustic data collected from a plurality of points along the trayed column 200. In particular, the time data may be labeled based on an operational condition of the trayed column 200 when the data was collected. In examples where the trayed column 200 is a lab column, the data may be labeled based on the operational condition caused by an operator by varying parameters of the trayed column 200. In examples where the trayed column 200 is a commercial column, the data may be labeled based on the operational condition determined by the operational condition determination module 406 based on the supplemental data received by the supplemental data reception module 404.

After receiving the data, the acoustic data reception module 402 may store the received data in the data storage component 308 in association with the labeled operational condition. As such, the control unit 300 may collect acoustic data from the trayed column 200 associated with a variety of operational conditions, which may be used to train the model, as disclosed herein.

At step 602, the frequency domain transformation module 410 transforms the time domain data into the frequency domain to obtain frequency domain data. The frequency domain data comprises amplitude and phase data at a plurality of frequency values at a plurality of points along the trayed column 200.

At step 604, the ambient noise determination module 408 determines an amount of ambient noise associated with the trayed column 200. The ambient noise removal module 412 then removes the ambient noise from the frequency domain data determined by the frequency domain transformation module 410 to obtain adjusted frequency domain data.

At step 606, the model training module 416 trains the model to classify the adjusted frequency domain data into one of a plurality of operational conditions using multivariate discriminant analysis. In particular, the model training module 416 trains the model to classify the adjusted frequency domain data into a particular operational condition using based on principal components determined using OPLS-DA. In the illustrated example, the plurality of operational conditions include at least normal operation, weeping, fouling, and foaming.

During training of the model, the frequency selection module 414 may select certain frequencies from among the frequency domain data to determine reduced frequency domain data. In particular, the frequency selection module 414 may select a subset of frequency values from among the frequency values determined by the frequency domain transformation module 410 such that each frequency value of the subset of frequency values captures more information associated with the operational condition of the trayed column 200 than each frequency value that is not among the subset of frequency values using regression analysis. That is, the frequency selection module 414 may select a plurality of frequency values that contain the most information for detecting operational conditions of the trayed column 200, as determined by one or more experts.

At step 608, the model training module 416 trains the model to determine an extent of an operational condition of the trayed column 200, such as jet flooding or downcomer backup. In embodiments, the model training module 416 may train the model to determine the extent of an operational condition of the trayed column 200 using regression analysis (e.g., PLS regression). After the model is trained, the determined parameters of the model may be stored in the data storage component 308 and the trained model may be used to determine an operational condition and/or an extent of an operational condition of the trayed column 200 during operation.

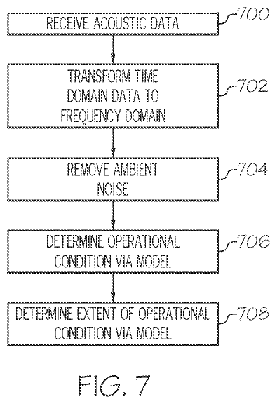

FIG. 7 depicts a flowchart of an example method for using the trained model to determine an operational condition and/or an extent of an operational condition of the trayed column 200 during operation. At step 700, the acoustic data reception module 402 receives acoustic data sensing measurements from the fiber optic cable 216 wrapped around the column 200. This data may comprise time domain acoustic data collected from a plurality of points along the trayed column 200. In some examples, the acoustic data reception module 402 may receive the data from the edge server 240 after the edge server determines, via unsupervised learning techniques, that the data has changed in a manner suggesting that the operational condition of the trayed column 200 may have changed.

At step 702, the frequency domain transformation module 410 transforms the time domain data into the frequency domain to obtain frequency domain data. The frequency domain data comprises amplitude and phase data at a plurality of frequency values at a plurality of points along the trayed column 200.

At step 704, the ambient noise determination module 408 determines an amount of ambient noise associated with the trayed column 200. The ambient noise removal module 412 then removes the ambient noise from the frequency domain data determined by the frequency domain transformation module 410 to obtain adjusted frequency domain data.

At step 706, the operational condition classification module 418 uses the trained model to determine the operational condition of the trayed column 200 based on the adjusted frequency domain data output by the ambient noise removal module 412. In particular, the frequency selection module 414 reduces the adjusted frequency domain data to only include amplitude and phase data associated with the frequency values containing the most information for determining the operational condition of the trayed column 200, thereby obtaining reduced frequency domain data. The operational condition classification module 418 then determines an operational condition of the trayed column 200 using the trained model, based on the principal components of the reduced frequency domain data.

At step 708, the operational condition quantification module 420 determines an extent of an operational condition of the trayed column 200 using the trained model, based on the reduced frequency domain data and/or the time domain data. After determining a classification and an extent of an operational condition of the trayed column 200, the control unit 300 may output the determined operational condition and operational condition extent to a user.

It should now be understood that embodiments described herein are directed to systems and methods for acoustic monitoring of trayed distillation columns. A fiber optic cable may be wrapped around an exterior surface of a trayed distillation column to measure the acoustic signal at various points along the distillation column. A model may be trained to determine an operational condition of the distillation column and the extent of the operational condition using labeled data associating acoustic data with different operational conditions.

A model may be trained to select frequency values that have the most information for determining different operational conditions of the distillation column. The model may be trained to classify the frequency domain data into one of a plurality of operational conditions using multivariate analysis. The model may also be trained to determine an extent of an operational condition of the distillation column using regression analysis.

After the model is trained, acoustic data may be collected from the fiber optic cable wrapped around the distillation column while the distillation column operates in real-time. The trained model may then be used to classify and/or determine an extent of an operational condition of the trayed distillation column based on the acoustic data. Accordingly, an operational condition of the trayed distillation column may be determined at various points along the distillation column during real-time operation of the distillation column.

It is noted that the terms “substantially” and “about” may be utilized herein to represent the inherent degree of uncertainty that may be attributed to any quantitative comparison, value, measurement, or other representation. These terms are also utilized herein to represent the degree by which a quantitative representation may vary from a stated reference without resulting in a change in the basic function of the subject matter at issue.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

1. A method for detecting an operational condition of a vessel containing two fluid phases moving past each other, comprising:
providing a fiber optic cable around an exterior surface of the vessel;
receiving time domain data comprising distributed acoustic sensing measurements from the fiber optic cable at a plurality of locations along the exterior surface of the vessel;
determining frequency domain data at each of the plurality of locations based on the time domain data;
performing an analysis of the frequency domain data and/or the time domain data using a pre-trained model; and
determining the operational condition of the vessel based on the analysis.

2. The method of claim 1, wherein the vessel comprises a trayed distillation column.

3. The method of claim 1, wherein performing the analysis comprises classifying the frequency domain data and/or the time domain data into one of a plurality of operational conditions using the pre-trained model.

4. The method of claim 3, wherein the plurality of operational conditions include at least normal operation, weeping, fouling and foaming.

5. The method of claim 3, further comprising classifying the frequency domain data and/or the time domain data into one of the plurality of operational conditions using multivariate discriminant analysis.

6. The method of claim 1, wherein performing the analysis comprises quantifying the frequency domain data and/or the time domain data to determine an extent of the operational condition of the vessel.

7. The method of claim 6, wherein the operational condition comprises at least one of jet flooding and downcomer backup.

8. The method of claim 1, further comprising:
receiving a measurement of ambient noise in a location where the vessel is located;
determining frequency domain data based on the time domain data;
removing the ambient noise from the frequency domain data to obtain adjusted frequency domain data; and
performing the analysis of the adjusted frequency domain data using the pre-trained model.

9. The method of claim 1, further comprising determining the frequency domain data by performing a transform of the time domain data from a time domain to a frequency domain at each of the plurality of locations to determine amplitude and phase data at a plurality of frequency values at each of the plurality of locations.

10. The method of claim 9, further comprising:
selecting a subset of frequency values from among the plurality of frequency values to obtain reduced frequency domain data; and
performing the analysis of the reduced frequency domain data using the pre-trained model.

11. A method for training a model to detect an operational condition of a vessel containing two fluid phases moving past each other, comprising:
providing a fiber optic cable around an exterior surface of the vessel;
receiving, from the fiber optic cable at a plurality of locations along the exterior surface of the vessel, time domain data comprising distributed acoustic sensing measurements at a plurality of time steps, wherein the time domain data at each time step is labeled based on the operational condition of the vessel at the time step when the time domain was collected;
determining the frequency domain data, associated with each of the operational conditions, at each of the plurality of locations based on the time domain data; and
training the model to determine the operational condition of the vessel based on the associations between the frequency domain data and/or the time domain data, and the labeled operational conditions.

12. The method of claim 11, further comprising:
causing a plurality of operational conditions to occur within the vessel; and
labeling the time domain data based on the operational conditions caused within the vessel at each time step.

13. The method of claim 11, further comprising:
receiving supplemental data associated with the vessel at each time step;
determining the operational condition of the vessel at each time step based on the supplemental data; and
labeling the time domain data based on the determined operational condition at each time step.

14. The method of claim 11, further comprising:
receiving a measurement of ambient noise in a location where the vessel is located;
determining frequency domain data based on the time domain data;
removing the ambient noise from the frequency domain data to obtain adjusted frequency domain data; and
training the model to determine the operational condition of the vessel based on the associations between the adjusted frequency domain data and the labeled operational conditions.

15. The method of claim 11, further comprising selecting a subset of frequency values from among the plurality of frequency values such that each frequency value of the subset of frequency values captures more information associated with the labeled operational conditions than each frequency value that is not among the subset of frequency values using regression analysis.

16. The method of claim 15, wherein the plurality of operational conditions include at least normal operation, weeping, fouling, and foaming.

17. The method of claim 11, further comprising training the model to determine an extent of the operational condition based on the frequency domain data and/or the time domain data.

18. The method of claim 17, wherein the operational condition comprises at least one of jet flooding and downcomer backup.

19. A system to determine an operational condition of a vessel containing two fluid phases moving past each other, comprising:
the vessel;
a fiber optic cable positioned around an exterior surface of the vessel; and
a control unit configured to:
receive time domain data comprising distributed acoustic sensing measurements from the fiber optic cable at a plurality of locations along the exterior surface of the vessel;
determine frequency domain data at each of the plurality of locations based on the time domain data;
perform an analysis of the frequency domain data and/or the time domain data using a pre-trained model; and
determine the operational condition of the vessel based on the analysis.

20. The system of claim 19, wherein the control unit is further configured to classify the frequency domain data and/or the time domain data into one of a plurality of operational conditions using multivariate discriminant analysis and/or determine an extent of an operational condition of the vessel.
